(19) United States
(12) Patent Application Publication
(10) Pub. No.: US 2016/0272831 A1
(43) Pub. Date: Sep. 22, 2016

(54) FLUID

(71) Applicant: ROLLS-ROYCE plc, London (GB)

(72) Inventors: Chek Sing TEO, Singapore (SG); Jie ZHANG, Singapore (SG); Sandor NEMETH, Singapore (SG); Wei Peng GOH, Singapore (SG)

(73) Assignee: ROLLS-ROYCE plc, London (GB)

(21) Appl. No.: 15/048,461

(22) Filed: Feb. 19, 2016

(30) Foreign Application Priority Data
Mar. 16, 2015 (GB) 1504395.3

(51) Int. Cl. C09D 11/38; B41J 2/01; C09D 11/106

(52) U.S. Cl. CPC C09D 11/38; C09D 11/106; B41J 2/01

(57) ABSTRACT

An ink jet ink that may be used to provide a stop-off layer on a metallic substrate, the ink including: Between 4.8% weight to 35.1% weight Yttria nanopowder; between 2.6% weight to 19.3% weight of a stabiliser; between 0.3% weight to 1.9% weight of a binder; between 0.01% weight to 5% weight of a surfactant and between 0% weight to 30% weight of a humectant and the balance water.

The present disclosure concerns a jettable fluid for an ink jet printer for producing a gas turbine component

Wide chord blades may be formed from a process involving superplastic deformation where multiple layers of metal are laminated together and diffusion bonded. The article is inflated between two mould elements to provide the blade. The blade has an internal structure that is defined in part by the application of a stop-off material that inhibits the diffusion bonding of the layers at the locations to which the stop-off material is applied.

The tolerances of the blade require that the positioning of the stop-off is carefully controlled and is applied by methods such as screen or inkjet printing. Previous inks seen for example in EP0266073 suffer from agglomeration and/or short shelf lives that make them unsuitable for use in ink-jet applications. Other yttria dispersions than may be suitable do not typically have a sufficient percentage of yttria to make them suitable as a stop-off.

The metal of the blade is non-porous which means that the inks must form stable features prior to drying or solidification of the ink. J. Am. Ceram. Soc. 94[11] 3787-3792 describes an aqueous ink with 10 vol % zirconium oxide that is suitable for inkjet printing. The ink was left for 24 hours with minimal sedimentation.

According to an aspect of the invention there is provided an ink jet ink for providing a stop-off layer on a metallic substrate, the ink comprising water as the carrier and between 10% weight to 35.1% weight yttria nanopowder; Between 2.6% weight to 19.3% weight of a stabiliser; between 0.3% weight to 1.9% weight of a binder; between 0.01% weight to 5% weight of a surfactant and between 0% weight to 30% weight of a humectant.

The yttria nanopowder may be present in amount that is above 15% by weight of the ink.

The yttria nanopowder may be present in amount that is above 20% by weight of the ink.

The The yttria nanopowder may be present in amount that is above 25% by weight of the ink.

The surfactant may be provided in an amount below 1% by weight of the ink.

According to a further aspect there is provided an aqueous ink jet ink for providing a stop-off layer on a metallic substrate, the ink comprising: between 1% volume to 10% volume yttria nanopowder; between 1% weight to 90% weight of a stabiliser based on the weight of yttria; between 0% weight to 10% weight of a binder based on the weight of yttria, and 0.01% weight to 10% weight of a surfactant based on the weight of yttria; and between 0% weight to 30% weight of a humectant based on the weight of yttria.

The stabiliser may be selected from the group comprising polymers and oligomers that act as steric stabilisers, such as Disperbyk-190™ available from Altana. The stabiliser may be a solution of a high molecular weight block copolymer with pigment affinic groups.

The binder may be selected from the group of water soluble polymers including: polyvinyl alcohol (PVA), polyethylene glycol or modified cellulose polymers such as hydroxypropyl methyl cellulose.

The surfactant may be selected from a group of materials that produce surface tension in aqueous solutions below 40 mN/m or more preferably below 35 mN/m when used in concentration of 2% or less by weight. The surfactant may be non-ionic. The surfactant may be selected from one or more of: octylphenol ethoxylates such as ones having the chemical formula C₁₄H₂₁O(C₂H₄O)ₙH where n is 9.5 on average, ethylene oxide/propylene oxide copolymers and nonylphenol ethoxylates.

The humectant may be selected from the group comprising polyols. The humectant may be selected from one or more of: glycerol (C₃H₈O₃), propylene glycol (C₃H₈O₂), and/or polypropylene glycols (HO—(C₃H₈O)ₙH).

According to a further aspect there is provided an ink jet ink according to any preceding claim comprising: 13.3 wt. % yttria, 7.3 wt. % a steric stabiliser, 0.7 wt. % PVA binder, 1 wt. % octylphenol ethoxylate surfactant, 0.75 wt. % glycerol humectant, the balance being water.

The skilled person will appreciate that except where mutually exclusive, a feature described in relation to any one of the above aspects of the invention may be applied mutatis mutandis to any other aspect of the invention.

Embodiments of the invention will now be described by way of example only.

A drop on demand inkjet printer comprises a plurality of chambers each having one or more nozzles. Pressure is applied to the ink within the chambers that cause it to be ejected through the nozzles.

The drop on demand inkjet print heads typically fall into two categories. The first applies pressure to the ink through the formation of a bubble that is generated from a heating element whilst the second uses a piezoelectric actuator that moves according to its polarization and the direction of an electric field applied through the piezoelectric material.

In conventional office-based printers the ink comprises a colourant that may be a soluble dye or a dispersed pigment. In industrial printers the colourant may be substituted by another functional particle made from material such as ceramics or metals.

The nozzles through which the ink is ejected are relatively small, typically of the order of a few microns up to tens of microns. It is desirable for the ink to be suitably stable so that it does not evaporate within the ejection chamber and, where the ink comprises dispersed particles, the particles do not agglomerate to a size that can block the nozzles.

With functional, or industrial, use the substrates to which the ink is deposited can similarly place constraints on the suitability of the ink. Many substrates are non-porous which affects the drying, or evaporation, of the ink and consequently the cohesion and/or coverage of the layer formed.

An aqueous ink has been developed that has the composition:

Yttria nanopowder: 10% weight to 35.1% weight

Stabiliser: 2.6% weight to 19.3% weight

Binder: 0.3% weight to 1.9% weight

Surfactant: 0.01% weight to 5% weight

Humectant: 0% weight to 30% weight

Water: balance

The yttria nanopowder is formed by putting yttria into a bead mill with zirconium dioxide beads and milling the Yttria until it reaches the required mean average size of between 20 and 600 nm. The smaller size limits the sedimentation of the particles from dispersion.

A stabilising additive is used to maintain a stable particle size distribution using steric stabilisation thereby preventing agglomeration. One additive that may be used is known as Disperbyk 190™ which is a copolymer with chemical structures that can attach to pigment particles, including yttria. The pigment affined groups of the stabiliser interact with the inorganic yttria particles and anchor the polymer to the particle surface. This process can be enhanced by maintaining a fairly large concentration of Disperbyk-I9O™ i.e. between 10 and 90% by weight of the amount of yttria in the dispersion.

The interaction of the stabilising agent and the Yttria is sufficient to sterically stabilise the dispersion for a shelf life of at least six months.

A binder such as PVA may be used to improve layer cohesion. Alternatives include polyethylene glycol and water soluble polymers.

A surfactant reduces the surface tension of the ink which allows it to spread on the non-porous metal blade to limit uneven spreading of the ink and undesirable features known as “coffee cup” staining that has better coverage at the edge of the droplet where it dries than in the centre of the droplet. One ingredient that has been found to be of use in the composition is an octylphenol ethoxylate known under the trade name Triton X-100™ (manufacturer: Dow Chemical Company; chemical formula C₁₄H₂₁O(C₂H₄O)ₙH where n is 9.5 on average). Other non-ionic surfactants may be substituted for some or all the octylphenol ethoxylate.

A humectant such as glycerol may be used to reduce evaporation and cracking of the deposited stop-off. This reduces cracking by plasticising the binder polymer and reducing the elastic modulus of the dried film. Alternatives include those comprising polyols, such as propylene glycol (C₃H₈O₂), and polypropylene glycols (HO—(C₃H₆O)ₙH).

An exemplary ink is described with reference to Example 1:

### EXAMPLE 1

| Component | Amount |
|---|---|
| Yttria nanopowder | 13.3 wt. % |
| Stabilizer (Disperbyk 190 ™) | 7.3 wt. % |
| Binder (PVA) | 0.73 wt. % |
| Surfactant (Triton X100 ™) | 1 wt. % |
| Humectant (Glycerol) | 0.75 wt. % |
| Water | Balance |

The ink has been formulated to limit and minimise chemical interactions with a titanium substrate such as that used in the manufacture of hollow wide chord fan blades. In particular, oxidation can affect the sub-surface microstructure of the titanium, which in turn can alter the diffusion bond thereby compromising the structural integrity of the eventual fan blade. In order to determine the affect the ink has on a titanium substrate, studies using Secondary Ion Mass Spectroscopy (SIMS) analysis were carried out to analyse the oxygen content on the titanium substrate after inkjet of the ink of Example 1. Comparisons with test samples prepared using existing manufacturing methods and stop-off indicated equivalence, with key chemical elements within acceptable tolerances.

The ingredients of Example 1 are mixed to create a formula that is industrially applicable for printing by a drop on demand inkjet printer. The inks have an acceptable drying time that limits the amount of care needed to prevent smudging or risk of dirt particles adhering to the substrate. Within acceptable time periods there is no unacceptable agglomeration of the particles or clogging in the nozzle. The image formed dries without unacceptable cracking or coffee staining. The dried deposited ink has sufficient yttria to works as a stop-off that prevents diffusion bonding occurring between titanium sheets used to manufacture a hollow aerofoil.

Positional accuracy of the deposited ink plays a key part of determining the quality of diffusion bonding and hence the structural integrity of the eventual hollow WCFB.

The inks may be used in an inkjet printer as a substitute process to screen printing. The inks offer reliable inkjet printing across simultaneous nozzles, by limiting particle agglomeration and minimising clogging in the nozzles.

The ink is deposited onto targeted areas of the titanium substrate with not more than +/−50 μm positional discrepancy around the periphery. Minimal satellite droplets are deposited on the titanium substrate, adjacent to the peripheries of the targeted printed areas.

The ink offers an acceptable drying time on the non-porous print substrate after deposition and no unacceptable cracking or coffee staining after drying.

The ink formulation could be used in a fully automated clean room which would reduce the amount of shop floor man power and the amount of overheads.

The formulation is applicable for the manufacture of titanium wide chord fan blades and may be applied to any field that requires the use of a stop-off during diffusion bonding or in brazing.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. An ink jet ink for providing a stop-off layer on a metallic substrate, the ink comprising water as the carrier and:
Between 10% weight to 35.1% weight volume yttria nanopowder;
Between 2.6% weight to 19.3% weight of a stabiliser;
Between 0.3% weight to 1.9% weight of a binder
Between 0.01% weight to 5% weight of a surfactant
Between 0% weight to 30% weight of a humectant.

2. An ink jet ink according to claim 1, wherein the stabiliser is one or more polymers or oligomers that sterically stabilise dispersed particles

3. An ink jet ink according to claim 1, wherein the binder is selected from the group of water soluble polymers comprising: PVA, polyethylene glycol, modified cellulose.

4. An ink jet ink according to claim 1, wherein the surfactant is selected from the group of materials that produce surface tension in aqueous solutions below 40 mN/m or below 35 mN/m when used in concentration of 2% by weight or less. comprising: octylphenol ethoxylates, ethylene oxide copolymer, propylene oxide copolymers, and/or nonylphenol ethoxylates.

5. An ink jet ink according to claim 1, wherein the humectant is selected from the group comprising polyols: glycerol, propylene glycol, or polypropylene glycol.

6. An ink jet ink according to claim 1, wherein the ink comprises yttria in an amount between 13 and 20% by weight of the ink.

7. An aqueous ink jet ink according to claim 1 comprising: 3 vol % yttria, 50 wt % stabiliser based on the weight of the yttria, 5 wt % PVA binder based on the weight of the yttria, 1 wt. % surfactant based on the weight of the dispersion and 0.75 wt. % humectant based on the weight of the dispersion .

8. A method of forming a titanium blank comprising the steps of depositing an aqueous ink jet ink from an ink jet printer to a surface of a first titanium sheet; wherein the ink comprises water as the carrier and:
Between 10% weight to 35.1% weight volume yttria nanopowder;
Between 2.6% weight to 19.3% weight of a stabiliser;
Between 0.3% weight to 1.9% weight of a binder
Between 0.01% weight to 5% weight of a surfactant
Between 0% weight to 30% weight of a humectant;
applying a second titanium sheet to the first surface; and diffusion bonding the first titanium sheet to the second titanium sheet.

9. An yttria diffusion barrier layer deposited by the method of claim 8.
